(19) United States
(12) Patent Application Publication
(10) Pub. No.: US 2019/0258827 A1
(43) Pub. Date: Aug. 22, 2019

(54) AUTHENTICATION SERVERS THAT AUTHENTICATE ITEMS PROVIDED BY SOURCE COMPUTER SERVERS

(71) Applicant: CA, Inc., New York, NY (US)

(72) Inventors: Mohammed Mujeeb Kaladgi, Bangalore (IN); Junaid Ahmed Jameel, Bangalore (IN); Ruqiya Nikhat Kaladgi, Bangalore (IN); Yashwant Ramkishan Sawant, Prabhani (IN); Sangharsh Aglave, Nagpur (IN)

(73) Assignee: CA, Inc., New York, NY (US)

(21) Appl. No.: 15/898,748

(22) Filed: Feb. 19, 2018

(51) Int. Cl. G06F 21/64; H04L 29/06; H04L 9/32

(52) U.S. Cl. CPC G06F 21/64; H04L 9/3247; H04L 63/0823

(57) ABSTRACT

An authentication server receives an item authentication query message requesting authentication of an item that is available from a computer server. An authentication score for the item is generated based on information contained in the item authentication query message. The authentication score is then provided for display at a client terminal. Authentication of the information contained in the item authentication query provides a level of computer security to end-users.

### TECHNICAL FIELD

The present disclosure relates generally to providing computer security to end-users and, more particularly, to authenticating content of messages communicated from computer servers through the Internet to end-users.

### BACKGROUND

The basic architecture of the web is built around resources that are exposed as URL-addressable endpoints. The URL can contain a protocol, Internet address, an optional port, and an optional string to distinguish between different APIs on a particular computer server. Every unique API has an associated unique web URL. Different APIs, such as getItemAvailability( ) and buyItem( ), will by distinguished by their different URLs.

Application programming interfaces (APIs) are a set of subroutine definitions, protocols, and tools for building application software that accesses resources available through the Internet. APIs build of the basic architecture of the World Wide Web, and are based on application of the HTTP protocol. However, certain characteristics of HTTP make APIs vulnerable to spoofing by hackers and provide limited verification of source.

APIs use the stateless HTTP protocol, which is a foundational element of the architecture of the World Wide Web. APIs are most often designed to be stateless, both to align with the characteristics of the HTTP protocol, and to simplify the development of high volume systems that scale by instantiating many parallel instances of a service.

This property of statelessness makes APIs particularly vulnerable to exploitation by hackers who may spoof another authentic website and/or complicates the ability of users to determine which business entities are legally associated with particular URLs and/or to determine authenticity of items associated with particular URLs.

### SUMMARY

Some embodiments disclosed herein are directed to methods by an authentication server. The authentication server receives an item authentication query message requesting authentication of an item that is available from a computer server. An authentication score for the item is generated based on information contained in the item authentication query message. The authentication score is then provided for display at a client terminal.

Authentication of information contained in the item authentication query messages communicated from the computer server through, e.g., the Internet, to a client terminal provides a level of computer security to end-users.

It is noted that aspects described with respect to one embodiment disclosed herein may be incorporated in different embodiments although not specifically described relative thereto. That is, all embodiments and/or features of any embodiments can be combined in any way and/or combination. Moreover, methods, systems, and/or computer program products according to embodiments will be or become apparent to one with skill in the art upon review of the following drawings and detailed description. It is intended that all such additional methods, systems, and/or computer program products be included within this description and protected by the accompanying claims.

### BRIEF DESCRIPTION OF THE DRAWINGS

Aspects of the present disclosure are illustrated by way of example and are not limited by the accompanying drawings. In the drawings:

FIG. 1 is a block diagram of a computer system that includes an authentication server that authenticates items available through computer servers through messaging from client terminals during communications sessions through a data network, in accordance with some embodiments;

FIG. 2 is a block diagram of another computer system that includes an authentication server that authenticates items available through various types of computer servers to a client terminal through messaging from client terminals during communications sessions through a data network, in accordance with some embodiments;

FIG. 3 is a block diagram of another computer system that includes an authentication server that authenticates items that are made available from an item server to a client terminal and which are sourced from an entity associated with a source server and distributed by another entity associated with a distributor server, in accordance with some embodiments;

FIG. 4 is a combined data flow diagram and flowchart of operations that may be performed by a client terminal, an item server, an authentication server, a distributor server, and a source server in accordance with some embodiments;

FIG. 5 is a block diagram of an authentication server that can be configured to perform operations disclosed herein in accordance with some embodiments; and

FIG. 6 is a block diagram of a client terminal that can be configured to perform operations disclosed herein in accordance with some embodiments.

### DETAILED DESCRIPTION

Various embodiments will be described more fully hereinafter with reference to the accompanying drawings. Other embodiments may take many different forms and should not be construed as limited to the embodiments set forth herein. Like numbers refer to like elements throughout.

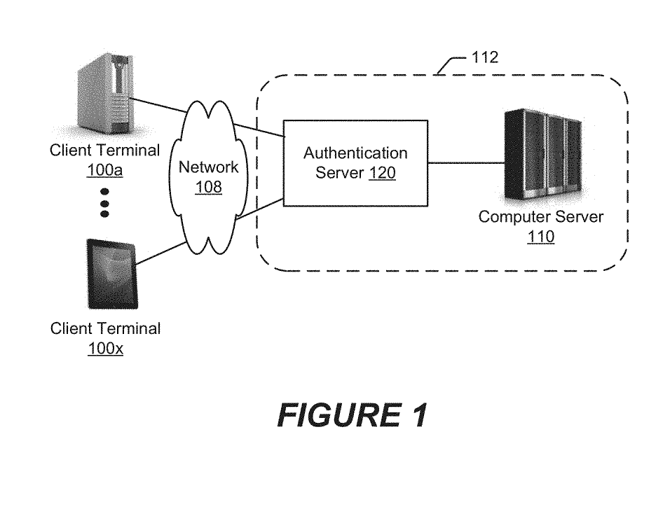

Various embodiments are directed to authenticating items that can be communicated from the computer server to client terminals through data networks, such as the Internet. Providing authentication of particular items contained in messages enables clients to ascertain what level of trust they can attribute to those items, and thereby improves security of operations and communications between user terminals and computer servers. FIG. 1 is a block diagram of a computer system that includes an authentication server 120 that authenticates items provided by the computer server 110 to the client terminals 100a through 100x (individually referred to as client terminal 100) through the data network 108, in accordance with some embodiments. The authentication server 120 receives a message, referred to as an item authentication query message, that requests authentication of an item that is available from the computer server 110. The authentication server 120 generates in authentication score for the item based on information contained in the item authentication query message. The authentication score is then provided for display at one or more of the client terminals, and is responsively used to control return communications from the client terminals 100a through 100x to the computer server 110.

Although the authentication server 120 is illustrated and described in many embodiments as being separate from the computer server 110, the operations disclosed herein as being performed by the authentication server 120 may be at least partially or entirely incorporated into the computer server 110. Accordingly, the authentication server 120 and computer server 110 can be collectively referred to as server 112 in some of the figures and description.

As will be explained in further detail, an item authentication query message can be received from a client terminal 100 and/or may be received from the computer server 110. In some embodiments, the item authentication query message contains a certification string for the item that is available through the computer server 110. The authentication score for the item is generated based on the certification string. Operations for generating the authentication score for the item based on the certification string, can include communicating a certification string query message containing a segment of the certification string toward a source server for authentication, and receiving from the source server a certification string authentication response message containing an indicated result of authentication of the segment of the certification string by the source server. The authentication score for the item can then be generated based on the indicated result of authentication of the segment of the certification string.

In a further embodiment, the operations for generating the authentication score for the item can include parsing the certification string into first and second segments. A first certification string query message containing the first segment of the certification string and not containing the second segment of the certification string is communicated toward a source server for authentication. Similarly, a second certification string query message containing the second segment of the certification string and not containing the first segment of the certification string is communicated toward a distributor server for authentication. A first certification string authentication response message is received from the source server and contains a first indicated result of authentication of the first segment of the certification string by the source server. Similarly, a second certification string authentication response message is received from the distributor server and contains a second indicated result of authentication of the second segment of the certification string by the distributor server. The authentication score for the item is then generated based on the first and second indicated results.

In another embodiment, the certification string contains a segment of a Uniform Resource Locator (URL) for an Internet address at which information is available from the computer server regarding the item, and the authentication score for the item is generated based on the segment of the URL. Operations to generate the authentication score for the item based on the segment of the URL, can include communicating a certification string query message containing the segment of the URL toward a source server for authentication, and receiving from the source server a certification string authentication response message from the source server containing an indicated result of authentication of the segment of the URL by the source server. The authentication score for the item is then generated based on the indicated result of authentication of the segment of the URL by the source server.

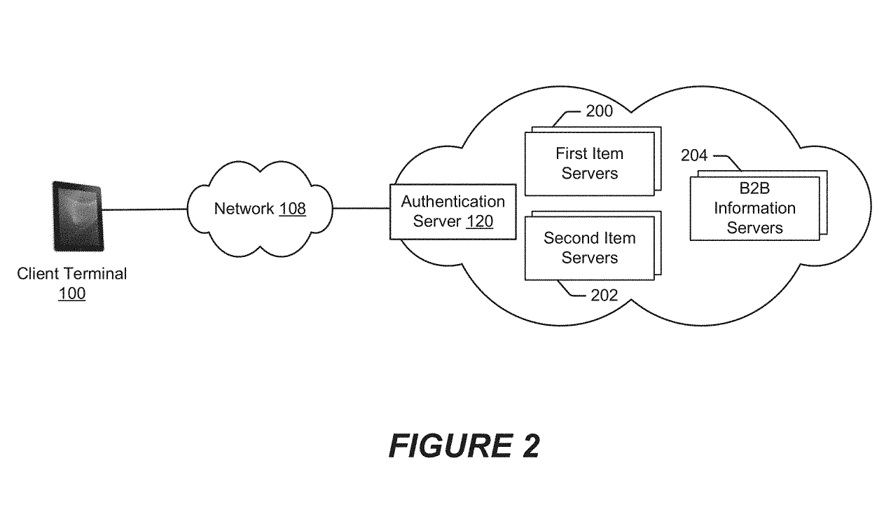

These and other embodiments are explained in further detail below with regard to FIGS. 2-6.

Electronic commerce has become an essential tool for the vending of retail products and services. Online commerce results in billions of dollars in sales of products and services online. Consumers benefit from the ease of access to products with which digital storefronts present products, with extensive catalogs, information and search capabilities. As well, electronic payment methods and tracking of shipments provide accountability and a history of transactions. This makes the Internet a major tool for trusted online vendors or traditional retailers like Office Depot, Home Depot, Nordstrom, Saks, and manufacturers, including Samsung, Apple, Sony, etc.

At the same time, anonymity, ease of publishing and advertising, and lack of transparency in the supply chain make it possible for less-than-honest vendors to hide their methods and persons from accountability to the consumer. Fraud in the representation and nature of products is prevalent, in part because the Internet separates customers from traditional storefront and related in-person transactions. Grey market and counterfeit products are often sold online via marketplace sites such as Amazon, eBay, and/or the like, with little information or recourse available to the consumer who receives poor quality products, or to the product manufacturer who objects to the use of their brand on such products or the misappropriation of their products.

The wide proliferation of online markets, by its nature, creates many channels for advertising, communications about products and services, and transactions for products and services. Such proliferation also magnifies the opportunities for online fraud, whether in the form of grey market or black market products, or simply unauthorized sale of authentic products and services. A chasm has emerged between the capacity of business and legal systems to identify and correct these problems, thus reducing the effective return of online markets to participant manufacturers and service providers. The present disclosure proposes to engage end-user purchasers, manufacturers and other sources of products, distributors that move products between manufacturers and online retailers and/or end-users, and/or online retailers in operations that generate authentication scores that indicate to end-user purchasers the likelihood that a product being sold through an on-line computer server of a particular retailer is genuine as having originated from a source (e g, manufacturer and/or distributor) operating with authority of an owner of a trademark for the product that was identified to the end-user for consideration when making a purchase decision through the computer server.

While the present disclosure refers to “manufacturers” and “products” for ease of discussion, one of skill in the art will recognize that “manufacturers” include any individual or entity that is a source of products to the market for sale, and “products” may include any products and/or services that may be offered for sale online, such as those provided by manufacturers of products, authorized distributors of products, providers of services, authors or distributors of copyrighted materials, individuals, and/or the like.

FIG. 2 is a block diagram of another computer system that operationally assists end-users who are considering making an online purchase from a retailer's website, i.e., via the retailer's computer server, with being able to evaluate the likelihood that a product sold through a website is an authentic product that originated from a source that has authority under an owner of the trademark. Although the end-user may visually observe the trademark printed or otherwise branded on a displayed image of the product and/or in the product name and/or product description provided by the product website page, such branding may be counterfeit, the product may be a lower-quality grey market product intended for distribution outside the geographic region of the end-user and/or via other distribution channels. Searching on a web site of a merchant that sources products from reputable distributors (e.g., the web site of a brick-and-mortar retailer such as Best Buy, Macy's, and/or the like brands) provides some assurance as to the source of products and reliability of the distributor, based on the reputation, service quality, and goodwill established by such merchants. However, searches of information resources that provide less controlled access to sellers (such as Amazon.com, shopping search engines, and/or the like) will likely yield wider sources for a product but will not provide reliable information about those who supply the products. Accordingly, certain types of information resources may provide a greater risk of encountering counterfeits and/or unlicensed distributors, and may make it difficult to identify or shut down such fraudulent product sources.

In the embodiment of FIG. 2, the system includes an authentication server 120 that authenticates items (e.g., products and/or services) that are available through various types of retail computer servers 200-204 for purchase by an end-user who is operating a client terminal 100 to communicate through a communication session established with one of the computer servers 200-204 through a data network 108.

As illustrated, retail computer servers 200-204 may include, without limitation, include merchant web servers 200 (referred to as first item servers), marketplace web servers 202 (referred to as second item servers), and business-to-business (B2B) information servers 204. While many sales through such product retailers are legitimate, each type of retail web server has differing levels of vulnerability for exploitation by parties attempting to distribute products without the authorization of the manufacturer. Each type of retail web server may present products and/or product information in a different way, and may pose different challenges for monitoring for problematic product sales.

Merchant web servers (first item servers) 200 can be provided by a brick-and-mortar retailer, such as Best Buy, Macy's, and/or the like brands which end-user purchasers can more reasonably trust as to the source of products and reliability of the distributor, based on the reputation, service quality, and goodwill established by such merchants.

In contrast, marketplace web servers (second item servers) 202 can be provided by Amazon.com, eBay, and/or the like where end-user purchasers should less reasonably trust that a product that is advertised as a particular brand is authentic because such marketplace retailers have less control over where sellers obtain the products that they sell through those marketplace websites. A marketplace web site 104 typically enables an indirect purchase where the marketplace web site 104 acts as a middle man that handles payments for new and/or used items. The marketplace web site 104 or the product source itself may ship the product to the end-user purchaser. Accordingly, certain types of products may have a greater risk of being counterfeits and/or provided by unlicensed distributors, and may make it difficult to identify or shut down such fraudulent product sources.

A marketplace web site 104 may allow companies and individuals to sell products without developing their own separate web presence. Examples of marketplace web sites 104 include, but are not limited to, Amazon.com, eBay, and the like. A marketplace web site 104 typically enables an indirect purchase where the marketplace web site 104 acts as a middle man that handles payments for new and/or used items. The marketplace web site 104 or the product source itself may ship the product to the customer.

A B2B information server 204 may enable domestic companies to participate in international trade with a minimal investment. Examples of a B2B information servers 204 include, but are not limited to, Alibaba.com®, DHGate.com, Made-in-China.com, and the like. A B2B information resource 102 typically arranges sales of new products from a foreign producer to a domestic reseller. B2B information resources 102 may provide a convenient way for international counterfeiters to export large volumes of product. Again, and-user purchasers should less reasonably trust that a branded product is authentic.

As will be explained in further detail below, the authentication server 120 can communicate with the client terminal 100 and the computer servers 200-204 that provide the retail websites, and may further communicate with a computer server operated by a source of products and/or a computer server that is operated by distributor of the products, to generate an authentication score indicates a likelihood that the product originated from a source and/or distributor that is operating under the authority of the owner of the trademark advertised as being associated with the product.

In some embodiments, the authentication server 120 receiving an item authentication query message and request authentication of a product, also referred to as an item, that is available from a computer server. The authentication server 120 generates an authentication score for the item based on information contained in the item authentication query message, and provides the authentication score for display at a client terminal. The authentication score can be used by an end-user or an application executed by the client terminal of the end-user, to determine whether a transaction should be completed through a particular retain website to purchase a particular advertised product. For example, a high authentication score may result in completion of a purchase transaction, while, in contrast, a low authentication score may result in prevent or termination of a purchase transaction before completion. As used herein, the term item is interchangeable with product. Accordingly, an “item” can be a product is available for sale through a computer server of a product retailer.

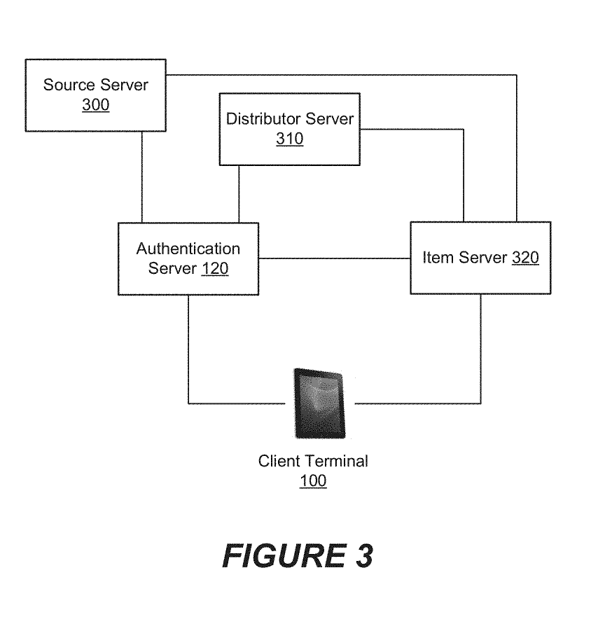

FIG. 3 is a block diagram of another computer system that includes an authentication server 120 that authenticates items that are made available from an item server 320, such as a retailers website, to a client terminal 100 and which are sourced from an entity (e g manufacturer) associated with a source server 300 and distributed by another entity associated with a distributor server 310, in accordance with some embodiments.

Referring to FIGS. 2 and 3, in one embodiment, purchasers can provide feedback on their determination of the likelihood that a product that they have purchased through a particular website, item server 320, is a genuine trademark branded product. Purchasers provide their feedback directly to the authentication server 120 and/or to the item server 320 which communicates such feedback to the authentication server 120. The feedback is used to generate an authenticity score for a product. A high authentication score may correspond to a purchaser having determined that the product that was received has a high likelihood of being authentic, which, in contrast, a low authentication score may correspond to a purchaser having determined that the product that was received has a low likelihood of being authentic (e.g., counterfeit), which a middle-range authentication score may correspond to a purchaser having determined that the product that was received is likely authentic but is a lower quality than expected for sale in the purchaser's geographic region and/or through a valid distribution channel (e.g., a grey market product intended by the source for sale outside the geographic region of the purchaser and/or intended for sale through a distribution channel other than the retailer of the present transaction, which may result in no warranty being extended to the purchased product by the source).

Operations that can be performed by the authentication server 120 to receive and process feedback from purchasers can include receiving feedback messages from client terminals 100, where each feedback message contains a feedback authenticity score, an identifier for the product that was purchased, and an identifier associated with the product retailer. The feedback authenticity scores indicate the purchasers' determinations of the likelihood that the product is genuine as having originated from a source that is operating with authority of an owner of a trademark for the product that was identified by the item server 320 to the client terminals 100, such as at the time that the purchasers were making their purchase decision as to the product.

The authentication server 120 generates an authentication score for the product based on the feedback authenticity scores. The authentication server 120 then stores, in a data structure of a crowdsourced product authentication repository, the authenticity score, the identifier for the product, and the identifier associated with the product retailer for future reference by the authentication server 120 and/or by the item server 320. The authentication server 120 provides the authentication score for the product to a client terminal 100 responsive to receiving from the client terminal 100 the item authentication query message containing the identifier for the product and the identifier associated with the product retailer.

When potential purchasers are browsing a retailer's website to purchase a product they may be presented with product information along with and an authenticity score for that product, where the authenticity score indicates the likelihood that the product is genuine. Alternatively, or additionally, the authenticity score may be provided to potential purchasers responsive to a query message that may be generated by the potential purchaser clicking or otherwise selecting an authentication-check icon that is displayed on the retailer's website, which in-turn initiates a query to the authentication server 120 to provide the authenticity score to the associated client terminal 100. Accordingly, the authentication query message can be generated by the item server 320 responsive to, e.g., a potential purchaser selecting an authentication-check icon, can be generated by the client terminal 100 by user initiating a query to determine the authenticity of a product that is being advertised by a particular retailer website, and/or may be generated by other elements in our operations that will be understood from the disclosure herein.

In some embodiments, some or all of the operations for generating the authenticity score described herein as being performed by authentication server 120 may alternatively or additionally be performed by the item server 320.

In another embodiment, operations by the authentication server 120 are performed by the item server 320 (e.g., retailer Web server). Responsive to a product selection indication being received from the client terminal 100, such as when a potential purchaser selects to view a product or selects an authentication-check icon, product description information and the authentication score for the product are communicated to the client terminal 100 for display. For example, a retailer's website can display product information along with the authentication score that has been generated for the product. In this manner, a potential purchaser can determine whether the product would satisfy their needs and further determine whether purchasing that product through this particular retailer's website will likely result in the purchaser obtaining the particular branded product that is expected and receive it through a distribution channel and retailer who is authorized by the source (e.g., a retailer who can extend a valid warranty from the source for the product).

The communication of the product description information and the authentication score to the client terminal 100 can be performed through a secure communication session. Following the communication of the product description information and the authentication score for the product to the client terminal, the item server 320 can receive a product purchase request from the client terminal 100, and responsively perform a product purchase protocol with the client terminal 100 through the secure communication session to complete a purchase transaction whereby the potential purchaser purchases the product from that retailer.

As explained above, the item can be a product that is available for sale through an on-line transaction performed through the computer server of a product retailer, which can be referred to as an item server 320. The item can be sourced from an entity, e g, manufacturer that operates a computer server, referred to as a source server 300, and can be distributed from the source to the retailer and/or directly to purchaser by a distributor that operates another computer server, referred to as a distributor server 310. In some further embodiments, the authentication score is generated based on communications between the authentication server 120 and the source server 300 and/or the distributor server 310. The authentication server 120 may provide an identifier for the product, which may further identify the retailer (such as the URL of the retailer's website or other identifier), to the source server 300 for authentication of the product as being an authentic product from that source (e.g., authenticated as being manufactured under the authority of a trademark owner of the advertised brand). Alternatively or additionally, the authentication server 120 may provide an identifier for the product, which may further identify the retailer (such as the URL of the retailer's website or other identifier), to the distributor server 300 for authentication of the product as being an authentic product and/or for authentication of the distributor as being an authorized distributor of the trademark owner of the advertised brand and/or the manufacturer.

Accordingly, generation of the authentication score can include determining an identifier of the source server 300 that is associated with an owner of a trademark for the product that was identified by the item server 320 to the client terminal 100. The authentication server 120 can communicate a product authentication query message containing an identifier of the product toward the identifier of the source server 300 for authentication. Authentication server 120 can receive from the source server 300 a product authentication response message containing a source authentication score for the product, and can responsively generate the authentication score based on the source authentication score.

In a further embodiment, the operations for communicating the product authentication query message containing the identifier of the product toward the identifier of the source server for authentication, can include performing an application programming interface (API) call that passes the identifier of the product to the source server 300. The operations for receiving from the source server 300 the product authentication response message containing the source authentication score for the product, can include receiving from the source server 300 a response to the API call containing the source authentication score for the product.

As used herein, an “API call” can be any signaling occurring from a client terminal to a computer server or other API endpoint that may be performed using a defined syntax and one or more parameters (e.g., data structure, object classes, and/or variables) to obtain data from an addressed resource and/or to provide data to the addressed resource. For example, SOAP and REST service requests can be performed using a defined API library of remote calls or other types of API requests. The client terminals 100a-100x or other types of source computers can be any type of computer that processes applications to generate API requests, such as Web service API calls, RESTful API requests, etc., and may include, but are not limited to desktop computers, laptop computers, tablet computers, smart phones, application servers, and mainframe computers. The computer server(s) may correspondingly be any type of computer(s) having applications that expose services and/or resources through APIs and process API requests received through APIs, such as Web service API calls, RESTful API requests, etc., and may include, but are not limited to mainframe computers, application server equipment, desktop computers, laptop computers, tablet computers, and smart phones.

In a further related embodiment, the operations for generating the authentication score for the item based on information contained in the item authentication query message, can include determining an identifier of a distributor server 310 that is associated with an entity responsible for movement of products, which include the product, before delivery to a user associated with the client terminal 100. The authentication server 120 communicates another product authentication query message containing the identifier of the product toward the identifier of the distributor server 310 for authentication, and receives from the distributor server 310 another product authentication response message containing a distributor authentication score for the product. The authentication server 120 responsively generates the authentication score based on the source authentication score and distributor authentication score.

Some additional embodiments are directed to generating an authentication score based on electronic communications through occur between the authentication server 120 and the item server 320, the distributor server 310, and/or the source server 300.

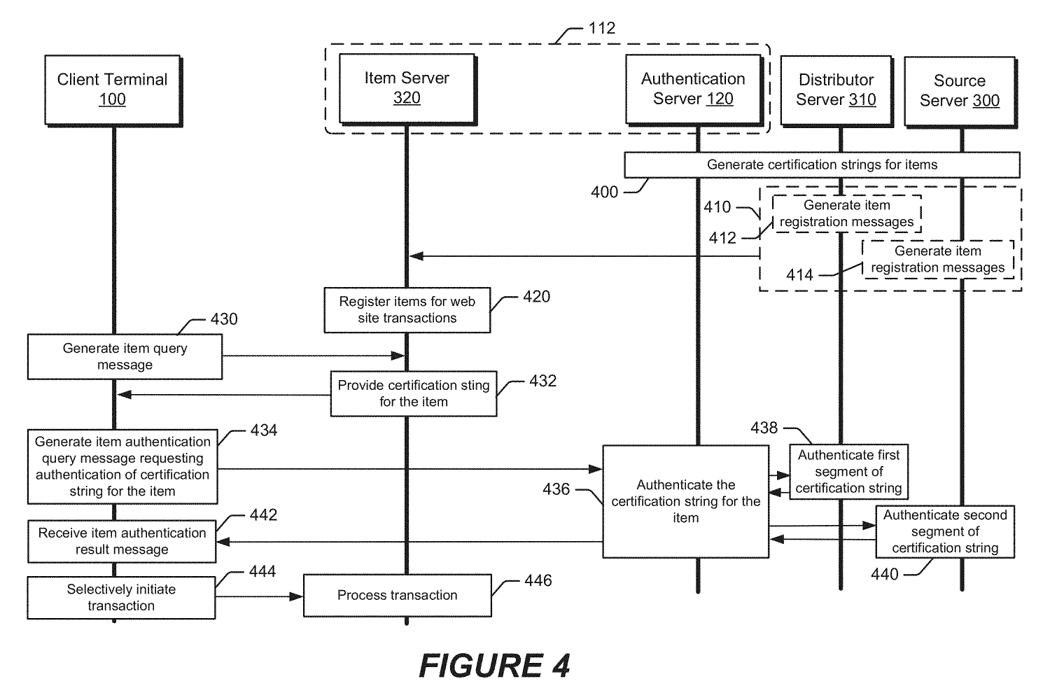

FIG. 4 is a combined data flow diagram and flowchart of operations that may be performed by a client terminal 100, an item server 320, an authentication server 120, a distributor server 310, and a source server 300 in accordance with some embodiments.

The item authentication query message can contain a certification string for the item that is available through the item server 320. The authentication score for the item can be generated based on the certification string.

The authentication server 120 may generate the authentication score for the item based on the certification string, based on communicating a certification string query message containing a segment of the certification string toward the source server 300 for authentication. The authentication server 120 receives from the source server 300 a certification string authentication response message containing an indicated result of authentication of the segment of the certification string by the source server 300. The authentication server 120 then generates the authentication score for the item based on the indicated result of authentication of the segment of the certification string.

In a further embodiment, the authentication server 120 may generate the authentication score for the item based on parsing the certification string into first and second segments. The authentication server 120 communicates a first certification string query message containing the first segment of the certification string and not containing the second segment of the certification string, toward the source server 300 for authentication. The authentication server 120 also communicates a second certification string query message containing the second segment of the certification string and not containing the first segment of the certification string, toward the distributor server 310 for authentication. The authentication server 120 receives a first certification string authentication response message from the source server 300 containing a first indicated result of authentication of the first segment of the certification string by the source server 300. The authentication server 120 also receives a second certification string authentication response message from the distributor server 310 containing a second indicated result of authentication of the second segment of the certification string by the distributor server 310. The authentication server 120 then generates the authentication score for the item based on the first and second indicated results.

In another further embodiment, the certification string contains a segment of a Uniform Resource Locator (URL) for an Internet address at which information is available from the item server 320 regarding the item. The authentication score for the item is generated based on the segment of the URL.

In a further embodiment, the authentication server 120 may generate the authentication score for the item based on communicating a certification string query message containing the segment of the URL toward the source server 300 for authentication, and receiving from the source server 300 a certification string authentication response message from the source server 300 containing an indicated result of authentication of the segment of the URL by the source server 300. The authentication server 120 then generates the authentication score for the item based on the indicated result of authentication of the segment of the URL by the source server 300.

These operations for generating a using the certification string for authentication are further illustrated in FIG. 4. Referring further to FIG. 4, the authentication server, 120, the distributor server 310, and the source server 300 can communicate 400 to generate certificate strings for items. For example, different items can be assigned different certification strings. Moreover, different distributors and different sources can be assigned different certification strings. A resultant certification string may be generated from a combination of certification string segments for the source, distributor, and item. The same item from two different sources can have different resultant certification strings, and the same item distributed through two different distributors can have a different resultant certification strings.

The resultant certification strings can be communicated 410 to the item server 320 for association with the respective items. For example, the distributor server 310 can generate item registration messages 412 that communicate certification string segments to the item server 320 for various items that it is associated with distributing to a retailer operating the item server 320. Similarly, the source server 300 can generate item registration messages 414 that communicate certification string segments to the item server 320 for various items that it is associated with sourcing for distribution to the retailer operating the item server 320.

The item server 320 can register 420 the items for website transactions, e.g., by generating a resultant certification strings for an item (product) that is to be advertised, by combining the certification string segments received for that item.

A client terminal 100 generates 430 an item query message (e.g., by a user selecting an advertised product to view more information or by selection a product to initiate a purchase process), which message is then communicated to the item server 320. The item server 320 responsively provides 432 the certification string (which is the resultant certification string) for the item to the client terminal 100. The client terminal 100 generates 434 an item authentication query message that is communicate to the authentication server 120 and requests authentication of the certification string received for the item.

The authentication server 120 authenticates 436 the certification string for the item by communicating a first certification string query message containing the first segment of the certification string to the source server 300 for authentication 440, and by communicating a second certification string query message containing the second segment of the certification string (and which may not contain the first segment of the certification string), to the distributor server 310 for authentication 438. The authentication server 120 generates 436 the authentication score for the item based on first and second indicated results of then authentications 440 and 438 received from the source server 300 and the distributor server 310, respectively. The authentication server 120 communicates an item authentication result message containing authentication score for the item to the client terminal 100.

The client terminal 100 receives 442 the item authentication result message. The authentication score for the item may be displayed on a display device of the client terminal 100 to an end-user. The authentication score for the item may be used by the end-user and/or directly by an application executing on the client terminal 100 to automatically control whether a purchase transaction for the item is initiated and/or completed. For example, when the authentication score for the item is below a define threshold level, the application may block initiation of a purchase transaction and/or terminal a purchase transaction before completion between the client terminal 100 and the item server 320. In contrast, responsive to the authentication score for the item being above the defined threshold level, the application may allow initiation of or allow continuance of a purchase transaction between the client terminal 100 and the item server 320, which then processes 446 the purchase transaction to complete a sale of the item to the end-user.

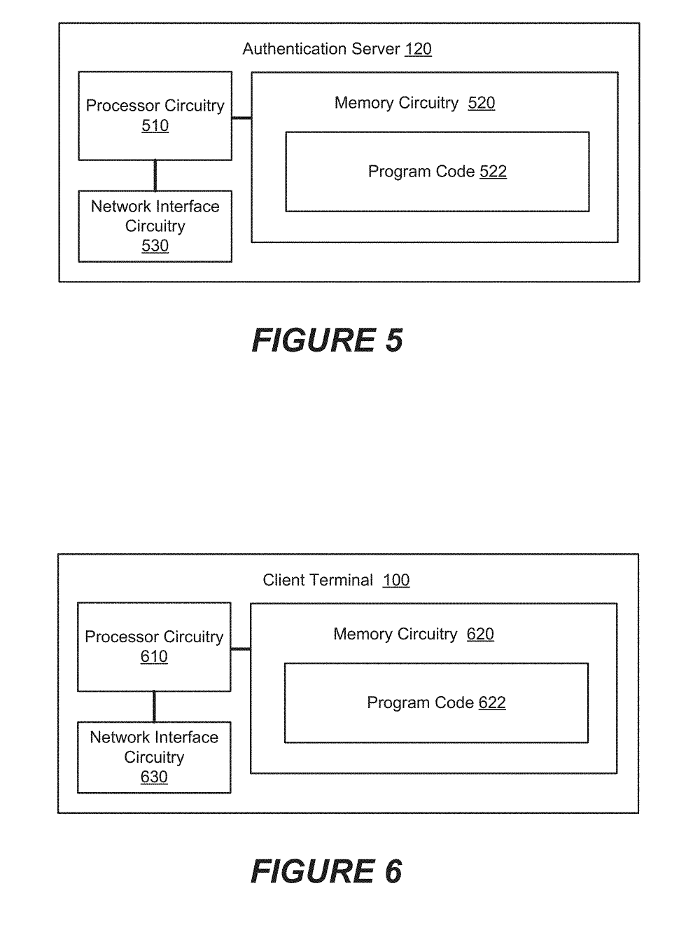

FIG. 5 is a block diagram of an authentication server 120 that can be configured to perform operations in accordance with some embodiments. Referring to FIG. 5, the authentication server 120 can include network interface circuitry 530 which communicates via the one or more data networks 108 with the client terminals 100a-100x, the computer server(s), and other components of the system. The authentication server 120 includes processor circuitry 510 and memory circuitry 520 that contains computer program code 522 which performs various operations disclosed herein when executed by the processor circuitry 510. The processor circuitry 510 may include one or more data processing circuits, such as a general purpose and/or special purpose processor (e.g., microprocessor and/or digital signal processor), which may be collocated or distributed across one or more data networks (e.g., network(s) 108). The processor circuitry 510 is configured to execute computer program instructions among the program code 522 in the memory circuitry 520, described below as a computer readable medium, to perform some or all of the operations and methods for one or more of the embodiments disclosed herein.

FIG. 6 is a block diagram of a client terminal 100 that can be configured to perform operations in accordance with some embodiments. Referring to FIG. 5, the client terminal 100 can include a network interface circuitry 630, e.g., which may include a wired network interface (e.g., Ethernet) and/or a wireless network transceiver interface (e.g., WiFi, cellular, etc.) which communicates via the one or more data networks 108 with the authentication server 120, the computer server(s), and other components of the system. The client terminal 100 includes processor circuitry 610 and memory circuitry 620 that contains computer program code 922 which performs various operations disclosed herein when executed by the processor circuitry 910. The processor circuitry 910 may include one or more data processing circuits, such as a general purpose and/or special purpose processor (e.g., microprocessor and/or digital signal processor), which may be collocated or distributed across one or more data networks (e.g., network(s) 108). The processor circuitry 610 is configured to execute computer program instructions among the program code 622 in the memory circuitry 620, described below as a computer readable medium, to perform some or all of the operations and methods for one or more of the embodiments disclosed herein.

### Further Definitions and Embodiments

As will be appreciated by one skilled in the art, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus, and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” or “/” includes any and all combinations of one or more of the associated listed items.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method by an authentication server comprising:
receiving an item authentication query message requesting authentication of an item that is available from a computer server;
generating an authentication score for the item based on information contained in the item authentication query message; and
providing the authentication score for display at a client terminal.

2. The method of claim 1, wherein:
the item authentication query message contains a certification string for the item that is available through the computer server; and
the authentication score for the item is generated based on the certification string.

3. The method of claim 2, wherein generation of the authentication score for the item based on the certification string, comprises:
communicating a certification string query message containing a segment of the certification string toward a source server for authentication;
receiving from the source server a certification string authentication response message containing an indicated result of authentication of the segment of the certification string by the source server; and
generating the authentication score for the item based on the indicated result of authentication of the segment of the certification string.

4. The method of claim 3, wherein generation of the authentication score for the item based on the certification string, further comprises:
parsing the certification string into first and second segments;
communicating a first certification string query message containing the first segment of the certification string and not containing the second segment of the certification string, toward a source server for authentication;
communicating a second certification string query message containing the second segment of the certification string and not containing the first segment of the certification string, toward a distributor server for authentication;
receiving a first certification string authentication response message from the source server containing a first indicated result of authentication of the first segment of the certification string by the source server;
receiving a second certification string authentication response message from the distributor server containing a second indicated result of authentication of the second segment of the certification string by the distributor server; and
generating the authentication score for the item based on the first and second indicated results.

5. The method of claim 2, wherein:
the certification string contains a segment of a Uniform Resource Locator (URL) for an Internet address at which information is available from the computer server regarding the item; and
the authentication score for the item is generated based on the segment of the URL.

6. The method of claim 5, wherein generation of the authentication score for the item based on the segment of the URL, comprises:
communicating a certification string query message containing the segment of the URL toward a source server for authentication;
receiving from the source server a certification string authentication response message from the source server containing an indicated result of authentication of the segment of the URL by the source server; and
generating the authentication score for the item based on the indicated result of authentication of the segment of the URL by the source server.

7. The method of claim 1, wherein the item comprises a product that is available for sale through the computer server of a product retailer, and further comprising:
receiving feedback messages from client terminals each containing a feedback authenticity score, an identifier for the product, and an identifier associated with the product retailer, wherein the feedback authenticity scores indicate users' determinations of likelihood that the product is genuine as having originated from a source operating with authority of an owner of a trademark for the product that was identified by the computer server to the client terminals;
generating an authentication score for the product based on the feedback authenticity scores;
storing in a data structure of a crowdsourced product authentication repository, the authenticity score, the identifier for the product, and the identifier associated with the product retailer; and
providing the authentication score for the product to the client terminal responsive to receiving from the client terminal the item authentication query message containing the identifier for the product and the identifier associated with the product retailer.

8. The method of claim 1, wherein the item comprises a product that is available for sale through the computer server of a product retailer, wherein the method by the authentication server is performed by the computer server, and further comprising:
responsive to a product selection indication received from the client terminal, communicating product description information and the authentication score for the product to the client terminal for display.

9. The method of claim 8, following the communication of the product description information and the authentication score for the product to the client terminal, and wherein the communication of the product description information and the authentication score, is performed through a secure communication session, further comprising:
receiving a product purchase request from the client terminal; and
performing a product purchase protocol between the computer server and the client terminal through the secure communication session.

10. The method of claim 1, wherein:
the item comprises a product that is available for sale through an on-line transaction performed through the computer server of a product retailer; and
generating the authentication score for the item based on information contained in the item authentication query message, comprises:
determining an identifier of the source server that is associated with an owner of a trademark for the product that was identified by the computer server to the client terminal;
communicating a product authentication query message containing an identifier of the product toward the identifier of the source server for authentication;
receiving from the source server a product authentication response message containing a source authentication score for the product; and
generating the authentication score based on the source authentication score.

11. The method of claim 10,
wherein communicating the product authentication query message containing the identifier of the product toward the identifier of the source server for authentication, comprises
performing an application programming interface (API) call that passes the identifier of the product to the source server; and
wherein receiving from the source server the product authentication response message containing the source authentication score for the product, comprises
receiving from the source server a response to the API call containing the source authentication score for the product.

12. The method of claim 11, wherein generating the authentication score for the item based on information contained in the item authentication query message, further comprises:
determining an identifier of a distributor server that is associated with an entity responsible for movement of products, which include the product, before delivery to a user associated with the client terminal;
communicating another product authentication query message containing the identifier of the product toward the identifier of the distributor server for authentication;
receiving from the distributor server another product authentication response message containing a distributor authentication score for the product; and
generating the authentication score based on the source authentication score and distributor authentication score.

13. An authentication server comprising:
a network interface configured to communicate with client terminals via the Internet;
a processor operationally coupled to the network interface for communications; and
a memory coupled to the processor and storing program code executable by the processor to perform operations comprising:
receiving an item authentication query message requesting authentication of an item that is available from a computer server;
generating an authentication score for the item based on information contained in the item authentication query message; and
communicating the authentication score for display at a client terminal.

14. The authentication server of claim 13, wherein:
the item authentication query message contains a certification string for the item that is available through the computer server;
communicating a certification string query message containing a segment of the certification string toward a source server for authentication;
receiving from the source server a certification string authentication response message containing an indicated result of authentication of the segment of the certification string by the source server; and
generating the authentication score for the item based on the indicated result of authentication of the segment of the certification string.

15. The authentication server of claim 14, wherein generation of the authentication score for the item based on the certification string, further comprises:
parsing the certification string into first and second segments;
communicating a first certification string query message containing the first segment of the certification string and not containing the second segment of the certification string, toward a source server for authentication;
communicating a second certification string query message containing the second segment of the certification string and not containing the first segment of the certification string, toward a distributor server for authentication;
receiving a first certification string authentication response message from the source server containing a first indicated result of authentication of the first segment of the certification string by the source server;
receiving a second certification string authentication response message from the distributor server containing a second indicated result of authentication of the second segment of the certification string by the distributor server; and
generating the authentication score for the item based on the first and second indicated results.

16. The authentication server of claim 13, wherein:
the item authentication query message contains a certification string for the item that is available through the computer server;
the certification string contains a segment of a Uniform Resource Locator (URL) for an Internet address at which information is available from the computer server regarding the item;
the authentication score for the item is generated based on the segment of the URL; and
generation of the authentication score for the item based on the segment of the URL, comprises:
communicating a certification string query message containing the segment of the URL toward a source server for authentication;
receiving from the source server a certification string authentication response message from the source server containing an indicated result of authentication of the segment of the URL by the source server; and
generating the authentication score for the item based on the indicated result of authentication of the segment of the URL by the source server.

17. The authentication server of claim 13, wherein the item comprises a product that is available for sale through the computer server of a product retailer, and the operations further comprise:
receiving feedback messages from client terminals each containing a feedback authenticity score, an identifier for the product, and an identifier associated with the product retailer, wherein the feedback authenticity scores indicate users' determinations of likelihood that the product is genuine as having originated from a source operating with authority of an owner of a trademark for the product that was identified by the computer server to the client terminals;
generating an authentication score for the product based on the feedback authenticity scores;
storing in a data structure of a crowdsourced product authentication repository, the authenticity score, the identifier for the product, and the identifier associated with the product retailer; and
providing the authentication score for the product to the client terminal responsive to receiving from the client terminal the item authentication query message containing the identifier for the product and the identifier associated with the product retailer.

18. The authentication server of claim 13, wherein:
the item comprises a product that is available for sale through an on-line transaction performed through the computer server of a product retailer;
generating the authentication score for the item based on information contained in the item authentication query message, comprises:
determining an identifier of the source server that is associated with an owner of a trademark for the product that was identified by the computer server to the client terminal;
communicating a product authentication query message containing an identifier of the product toward the identifier of the source server for authentication;
receiving from the source server a product authentication response message containing a source authentication score for the product; and
generating the authentication score based on the source authentication score.

19. The authentication server of claim 18,
wherein communicating the product authentication query message containing the identifier of the product toward the identifier of the source server for authentication, comprises
performing an application programming interface (API) call that passes the identifier of the product to the source server; and
wherein receiving from the source server the product authentication response message containing the source authentication score for the product, comprises
receiving from the source server a response to the API call containing the source authentication score for the product.

20. The authentication server of claim 19, wherein generating the authentication score for the item based on information contained in the item authentication query message, further comprises:
determining an identifier of a distributor server that is associated with an entity responsible for movement of products, which include the product, before delivery to a user associated with the client terminal;
communicating another product authentication query message containing the identifier of the product toward the identifier of the distributor server for authentication;
receiving from the distributor server another product authentication response message containing a distributor authentication score for the product; and
generating the authentication score based on the source authentication score and distributor authentication score.
